(19) United States
(12) Patent Application Publication
(10) Pub. No.: US 2007/0214192 A1
(43) Pub. Date: Sep. 13, 2007

(54) Change monitoring program for computer resource on network

(75) Inventors: Takeomi Murakami, Kawasaki (JP); Kenji Takahashi, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/590,171

(22) Filed: Oct. 31, 2006

(30) Foreign Application Priority Data
Mar. 10, 2006 (JP) 2006-066215

(51) Int. Cl. G06F 17/30

(52) U.S. Cl. 707/202

(57) ABSTRACT

A change monitoring program is executed by a processor of a server computer that includes a communication device that communicates with a managing target computer through a network and a change-plan database that stores details of resource changes for the managing target computer. The management target computer voluntarily detects a resource change by executing an agent program to describe the resource change as a log and to transmit the log. The program makes the processor execute a comparison process and a registration process. In the comparison process, receiving the log from the managing target computer, the processor compares the content of resource change described in the log to the details of resource changes stored in the change-plan database. When the content of resource change in the log matches any resource change in the database, the processor registers the information showing that the change is as planned to the change-plan database.

### BACKGROUND OF THE INVENTION

The present invention relates to a change monitoring program executed by a processor of a server computer in order to monitor resource changes of computers connected via a network.

For example, the information about a resource of a computer connected to a network is collected by a management server through the network using SNMP (Simple Network Management Protocol). The management server controls the resources of computers on the network intensively. Network management according to the SNMP is performed by collaboration of an agent program that resides on the managing target computer and a manager program that is executed on the management server. Namely, when a CPU that executes the manager program on the managing target computer (it is simply referred to as a “manager”, hereinafter) requests information about a monitoring target computer from a CPU that executes the agent program on the managing target computer (it is simply referred to as an “agent”, hereinafter), the agent acquires the predefined information in a MIB (Management Information Base) and transmits it to the manager. Then, the manager can judge the condition of the current monitoring target computer with reference to MIB that has the same contents as that above-mentioned.

Further, the international publication WO/2000/007099 discloses that a change of a platform or a product is checked in the view from a template by monitoring a computer system.

The methods of the conventional network managements, including that of the above-mentioned patent document, merely aim to know the composition of the current resources of the computers on the Network. Therefore, when a predetermined resource change at a predetermined time is planned, an operator must check the construction of the computer resource before the predetermined time against that after the predetermined time to verify that the resource has been changed as planned, which requires much time and effort.

### SUMMARY OF THE INVENTION

An object of the present invention is to provide an improved mechanism, which can easily verify that a resource has been changed as planned after the fact, when a predetermined resource change at a predetermined time is planned.

A change monitoring program for a computer resource on a network according to a first aspect of the present invention is executed by a processor of a server computer that includes a communication device that can communicate with a managing target computer through a network and a change-plan database that stores details of resource changes for the managing target computer. The management target computer can voluntarily detect a resource change by executing an agent program to describe the resource change as a log and to transmit the log. The program makes the processor execute a comparison process and a registration process. In the comparison process, when the communication device receives the log transmitted by the managing target computer, the processor compares the content of resource change described in the log to the details of resource changes stored in the change-plan database. When the content of resource change described in the logmatches any of the details of resource changes stored in the change-plan database, the processor executes the registration process to register the information showing that the resource has been changed as planned to the change-plan database.

With this program, the processor searches the change-plan database for the resource change whose detail matches the content of the log every time when the communication device receives a log transmitted by the managing target computer. When the processor has found such a resource change from the change-plan database, the information showing that the resource change registered in the change-plan database has been executed as planned is registered to the change-plan database. As a result, an administrator can check whether the resource change registered in the change-plan database has been executed as planned or not immediately after the resource change on each managing target computer without verification that requires much time and effort. Since the processor searches the change-plan database for the resource change whose detail matches the log only, the search load to the processor can be reduced.

A second aspect of the change monitoring program of a computer resource on a network according to the present invention is executed by a processor of a server computer that includes a communication device that can communicate with a managing target computer through a network, a change-plan database that stores details of resource changes for the managing target computer, a log database that stores the logs, and an input device through which an administrator inputs commands. The management target computer can voluntarily detect a resource change by executing an agent program to describe the resource change as a log and to transmit the log. The program makes the processor execute a storing process, a comparison process and a registration process. In the storing process, when the communication device receives a log transmitted by a managing target computer, the processor stores the received log into the log database. In the comparison process, when a command that designates a predetermined time period is input through the input device, the processor compares the content of resource change described in the log to the details of resource changes stored in the change-plan database for each of the logs received during the time period among the logs stored in the log database. When the content of resource change described in the log matches any of the details of resource changes stored in the change-plan database, the processor executes the registration process to register the information showing that the resource has been changed as planned to the change-plan database.

With this program, even when the communication device receives a log transmitted by the managing target computer, the processor does not search the change-plan database immediately, and the received log is stored into the log database. Then, when the administrator inputs a command through the input device, the processor extracts the logs received during the designated time period from the log database and searches the change-plan database for a resource change whose content matches each of the extracted logs. When the processor has found such a resource change from the change-plan database, the information showing that the resource change registered in the change-plan database has been executed as planned is registered to the change plan database. As a result, an administrator can check whether the resource change registered in the change-plan database has been executed as planned or not immediately after the resource change on each managing target computer without verification that requires much time and effort. Since the processor searches the change-plan database for the resource changes that are executed during the time period designated by the command only, the search load to the processor can be reduced.

According to the present invention constituted as mentioned above, an user can easily verify that a resource has been changed as planned after the fact, when a predetermined resource change at a predetermined time is planned.

### DESCRIPTION OF THE ACCOMPANYING DRAWINGS

FIG. 1 is a block diagram showing an outline configuration of a network system of a first embodiment according to the present invention,

FIG. 2 is a table showing data structure of a change-plan DB,

FIG. 3 is a table showing a data structure of an event log,

FIG. 4 is a table showing a data structure of inventory DB,

FIG. 5 is a flowchart showing processes according to an agent, a manager, and a change management program,

FIG. 6 is a flowchart showing a subroutine executed in S103 of FIG. 5,

FIG. 7 is a table showing contents of an event log that is notified from an agent to a manager,

FIG. 8 is a block diagram showing an outline composition of a network system of a second embodiment according to the present invention,

FIG. 9 is a table showing a data structure of a change plan task,

FIG. 10 is a flowchart showing a process according to a change management program, and

FIG. 11 is a table showing contents of an event log that is notified from an agent to a manager.

### DESCRIPTION OF THE PREFERRED EMBODIMENTS

Hereafter, embodiments of the present invention will be described with reference to drawings.

### First Embodiment

In the first embodiment, when an event that is a resource change in a managing target computer occurs, an agent voluntarily notifies a manager of the information about the resource change (that is, change-notifying-event information). A server automatically checks whether the resource was changed as planned by comparing the change-notifying-event information with details of the planned resource change. The manager of the management server does not compare a change plan to a change accomplishment based on the information transmitted from the agent of the managing target computer in response to a requirement, or based on the information collected and notified by the agent at fixed intervals. In addition, inventories mean various resources including hardware resources added to the managing target computer and software resources installed therein. Information about inventories is referred to as inventory information.

Thus, when using event notification by a trap, a time-lag between the resource change and the acquisition of the change-notification-event information becomes shorter than a periodical collection of inventory information by polling. Although the inventory information collected at once from all computers on the network must be searched in the latter case, only the change-notification-event in formation about a resource change is notified every time when the computer resource is changed in the former case. Therefore, the former case can reduce the search load caused by the change monitoring program.

Hereafter, a configuration and an operation of the first embodiment will be described concretely.

### <System Configuration>

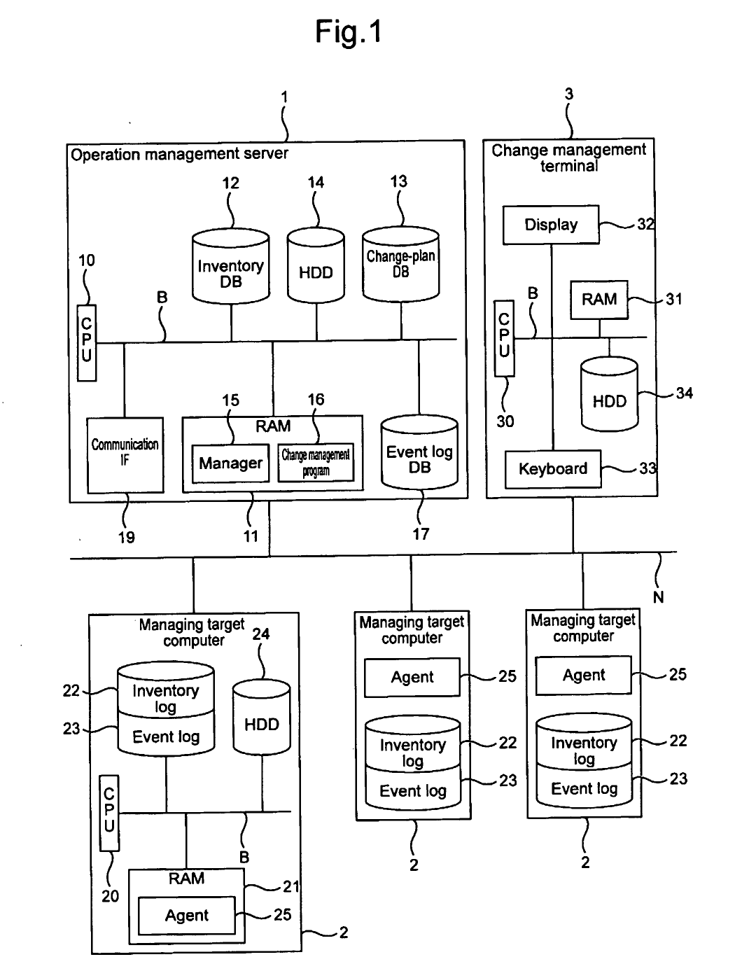

FIG. 1 is a block diagram showing an outline configuration of a network system that is managed by the change monitoring program of the first embodiment. As shown in FIG. 1, the network system consists of a plurality of computers 1 through 3 that are mutually connected via a network. One of these computers is an operation management server 1 that manages a network resource by executing a manager program etc., and another one is a console (a change management terminal 3) that accesses the operation management server 1 to make it execute a predetermined process according to the operation by an administrator and displays process results to the administrator. The other computers are managing target computers 2 whose resources are managed by the operation management server 1.

The operation management server 1 as a server computer is provided with a CPU 10, a RAM 11, an inventory DB (database) 12, a change plan DB 13, an event log DB 17, a hard disk 14 that stores programs, and a communication interface 19 as main components. These components are mutually connected via a bus B.

The CPU 10 is a central processing unit that executes a predetermined process by executing a program read from the hard disk 14. The RAM 11 is a main memory on which the program read from the hard disk drive 14 is cached and its workspace is developed, when the CPU 10 executes the above-mentioned process.

The change plan DB 13 is a database that stores change plans for resources of each managing target computer 2 beforehand. The change plans are inputted through the console (the change management terminal) 3. That is, details of the planned resource changes for the managing target computers are stored in the change plan DB. Although the change plan DB 13 may be stored in the hard disk 14 for storing programs, FIG. 1 is illustrated assuming that the change DB 13 is stored in a separate hard disk for convenience. The data structure of the change plan DB 13 will be described in detail later.

The hard disk 14 for storing programs is a disk device into which various programs that are read and executed by the CPU 10 are installed. One of these various programs is a manager program 15 that collaborates with an agent (described later) of the managing target computer. The manager program 15 collects (polls) inventory information notified from the agent and receives event information transmitted from the agent. Another one is a change management program 16 that checks whether a resource was changed as planned by comparing the received event information to the change plans in the change plan DB 13. The manager program 15 and the change management program 16 may be separate and independent programs, or may be combined as a single program. When these two programs are separately independent, the CPU 10 that operates according to the change management program 16 may be executed on the change management terminal 3. In such a case, the change plan DB 13 may be mounted on the change management terminal 3. Hereafter, a function that is implemented by the CPU 10 that reads and executes the manager program 15 is referred to as a manager 15.

The inventory DB 12 is a database (equivalent to an event database) that stores the inventory information periodically collected by the manager program 15. The event log DB 17 is a database that stores an event notification (an event log) that shows a resource change received by the manager program 15. Although the inventory DB 12 and the event log DB 13 may be stored in the hard disk 14 for storing programs, FIG. 1 is illustrated assuming that the inventory DB 12 and the event log DB are stored in separate hard disks for convenience. The data structure of the inventory DB 12 will be described in detail later.

The communication interface 19 is a communication device that communicates with another device through the network N according to a predetermined communications protocol.

The change management terminal 3 is a computer that accesses the operation management server 1 and makes it execute a predetermined operation. The terminal 3 is provided with a CPU 30, a RAM 31, a display 32, a keyboard 33, and a hard disk 34, which are mutually connected through the bus B The function of each of these components is common. However, programs stored in the hard disk 34 make the CPU 30 implement the above-mentioned functions. The change management terminal 3 containing the keyboard 33 corresponds to the input device that inputs a predetermined command to the server computer 1 according to the operations by the administrator.

Although the managing target computers 2 are different in composition, that is, they have different hardware resources and software resources, each of them includes a CPU 20, a RAM 21, and a hard disk 24 that are mutually connected via a bus B as common components. Various programs that are cached onto the RAM 21 and executed by the CPU 20 are installed in the hard disk 24. One of them is an agent program 25. The agent program 25 makes the CPU 20 perform a function to respond to the manager 15 in response to a request from the manager 15 received by polling as with a prior art. Alternatively, the agent program 25 performs a function to investigate resources of the managing target computer 2 concerned, to generate an inventory log 22 based on the investigation result, and to respond to the manager 15. Further, the agent program 25 makes the CPU 20 perform a function to detect a change in the hardware resources or software resources in the managing target computer 2 concerned voluntarily, to generate an inventory log 23 that describes a content of the resource change at the chance, and to notify the manager 15 of the content as the change-notifying-event information (the event notification). Hereafter, a function that is implemented by the CPU 20 that reads and executes the agent program 25 is referred to as an agent 25. The inventory log 22 and the event log 23, which are generated on the RAM 21 in the managing target computer 2, may be eliminated after they are transmitted to the operation management server 1. However, they may be stored in a file in storage such as a hard disk.

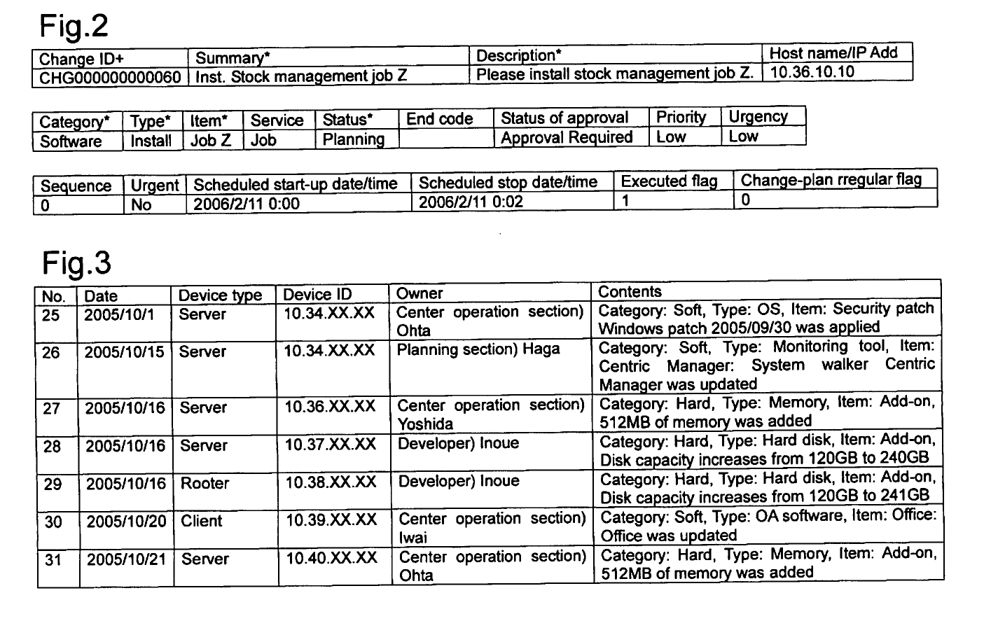

FIG. 2 is a table showing data structure of the change plan DB 13. The details of resource change plan for each managing target computer 2 are stored in the entries of the change plan DB 13, respectively. Namely, the entries of the change plan DB 13 consist of fields of a change ID, a summary, a description, a host name, a category, a type, an item, service, status, an end code, status of approval, a priority, urgency, a sequence, urgent, a scheduled start-up date/time, a scheduled stop date/time, an executed flag, and a change-plan irregular flag. Among these, the identification information (change ID) that identifies resource change plan concerned uniquely is stored in the change ID field. An outline of the resource change plan concerned is stored in the summary field. A sentence that directs the change operation by the resource change plan concerned is stored in the description field. An IP address or a host name that uniquely identifies the managing target computer concerning the resource change plan concerned is stored in the host name field. A category of the resource to be changed is stored in the category field. A type of the change is stored in the type field. The indigenous name of the resource to be changed is stored in the item field. The service implemented with the resource to be changed is stored in the service field. An execution condition of the resource change plan concerned is stored in the status field. Whether the resource change has been planned is stored in the end code field. Whether the approval of a person in charge for the resource change plan concerned is acquired is stored in the status of approval field. The information about priority (high or low) of the resource change plan concerned is stored in the priority field. The information about urgency (high or low) of the resource change plan concerned is stored in the urgency field. The information about the presence or absence of a change plan task (described below, but it is not used in this embodiment) related with the resource change plan concerned is stored in the sequence field. Whether an execution of the resource change plan concerned is urgent (yes or no) is stored in the urgent field. The date and time when the resource change plan concerned should start is stored in the scheduled start-up date/time field. The date and time when the resource change plan concerned should stop is stored in the scheduled stop date/time field. The flag showing that the resource change plan concerned has been executed is set in the executed flag field. The flag showing that the unplanned resource change has been executed is set in the change-plan irregular flag field.

FIG. 3 is a table showing the data structure of the change-notifying-event information that was notified from the agent 25 of the managing target computer to the manager 15. Namely, the table shows data structure of the event log. The example of FIG. 3 shows a condition where seven pieces of the change-notifying-event information (event logs) whose serial numbers are “25” through “31” are notified to the manager in order. As shown in FIG. 3, each piece of change-notifying-event information (event log) consists of a number (No.) field, a date field, a device type field, a device ID field, an owner field, and a contents field. The serial number that shows the order of receipt of the change-notifying-event information (event log) concerned by the manager 15 is described in the number field. The date when the event information (event log) concerned was generated is described in the date field. The type of the managing target computer 2 that generated the change-notifying-event information (event log) concerned is described in the device type field. The IP address of the managing target computer 2 that generated the change-notifying-event information (event log) concerned is described in the apparatus ID field. The name of the owner (or the user) of the managing target computer 2 that generated the change-notifying-event information (event log) concerned is described in the owner field. The contents (a category, a type, an item, contents) of the resource change that served as the impetus for generating the change-notifying-event information (event log) concerned are described in the contents field. Although such change-notifying-event information (event log) is temporarily stored on the RAM 11, it may be immediately stored in the inventory log DB 13 as an insurance against a system-down of the operation management server 1.

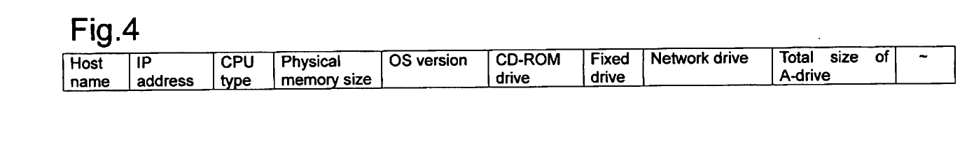

FIG. 4 is a table showing the data structure of the inventory DB 12. The inventory DB 12 contains records each of which stores contents of each inventory log that is received by the manager 15 from an agent 25 of a managing target computer. Each of the records contains the Information such as the host name, the IP address, the CPU type, the physical memory size, the OS version, the CD-ROM drive, the fixed drive, the network drive, and the total size of A-drive of the managing target computer that transmitted the inventory log.

### <Process>

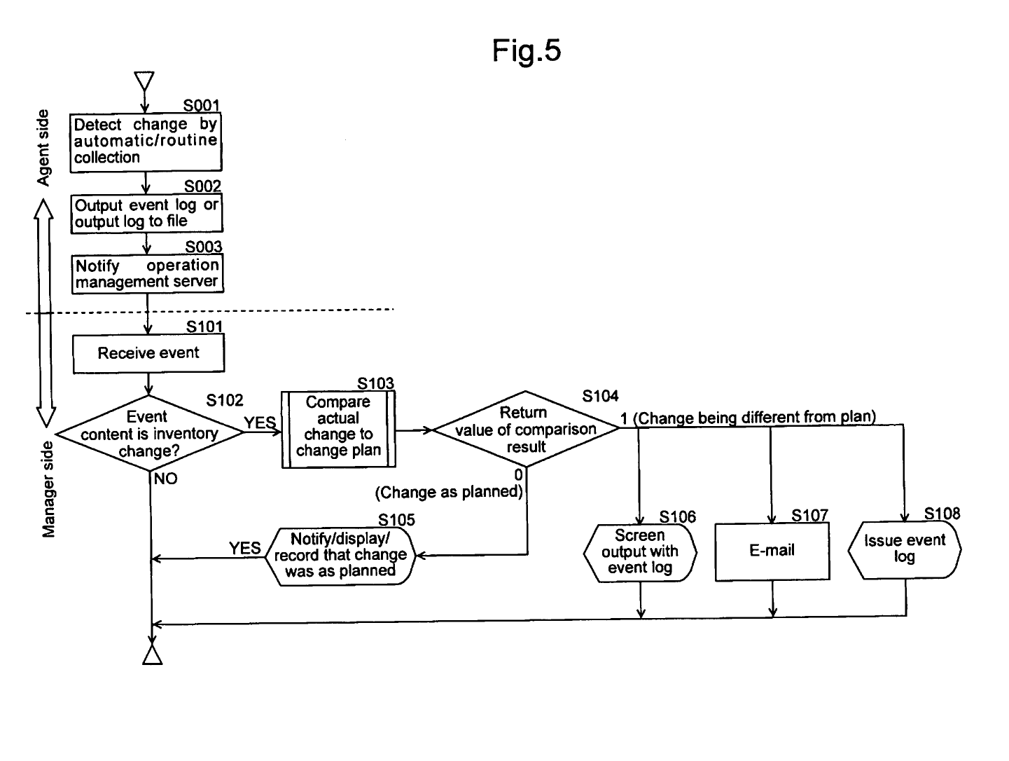

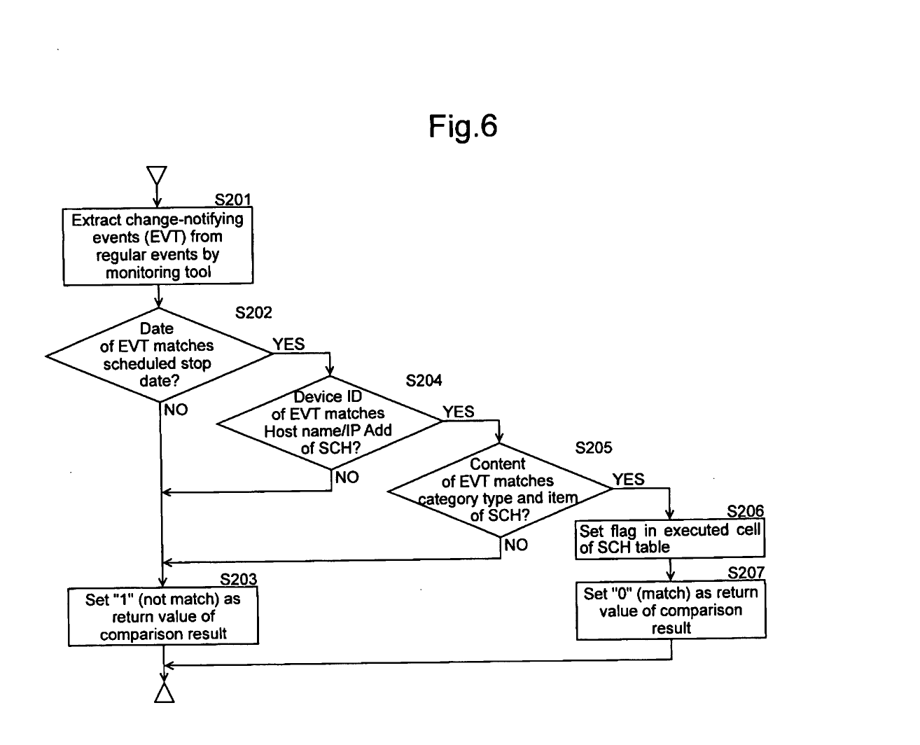

Next, a flow of a process of the embodiment that is executed by the agent 25 of the respective managing target computers 2 in collaboration with the manager 15 of the operation management server 1 (and the change management program) will be described with reference to the flowcharts in FIGS. 5 and 6. In FIG. 5, the steps positioned at the “agent side” are executed by the agent 25, and the steps positioned at the “manager side” are executed by the manager 15 and by the change management program 16.

The process of the flowchart in FIG. 5 starts at the time when the agent 25 detects information (S001). That is, the process starts when the agent 25 periodically collects the inventory information in response to an request from the manager 15, or when the agent 25 automatically detects a change of resource (a hardware resource or a software resource) such as an installation of new software and an addition of memory in its own computer 2.

In the next step S002, the agent 25 outputs the information detected in S001 as a log. That is, when the inventory information is periodically collected, the agent 25 generates an inventory log in which contents of the collected inventory information are described. When the resource change is automatically collected, the agent generates an inventory log in which contents of the resource change are described. Then, the agent 25 outputs the generated inventory log to a file.

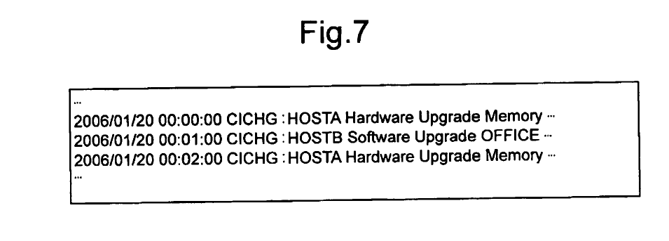

In the next step S003, the agent 25 transmits the log (the inventory log, the event log (change-notifying-event information)) generated in S002 to the manager 15. FIG. 7 shows an example of contents of a series of event logs (change notifying event) that are transmitted as this manner.

On the other hand, the manager 15 of the operation management server 1 receives the log (the inventory log, the event log (change-notifying-event information)) which agent 25 has transmitted in S003 in S101.

In the next step S102, the CPU 10, which operates according to the change management program 16, checks whether the log that is received in S101 contains the event log (change-notifying-event information) showing an inventory change (namely, a resource change of the managing target computer). And when the event log (change-notifying-event information) showing an inventory change is not contained, the process finishes as it is. On the other hand, when the event log (change-notifying-event information) showing an inventory change is contained, the manager 15 compares the contents of the resource change described in the event log concerned (change-notifying-event information) to the resource change plan stored in the change plan DB 13 in S103 (corresponding to the comparison means). FIG. 6 is a flow chart that shows a subroutine executed in S103.

In a first step S201 of the subroutine, the CPU 10, which operates according to the change management program 16, extracts the event log (change-notifying-event information) from the logs received from the agent 25 in S101.

In the next step S202, the CPU 10 searches the change plan DB 13 for a record whose value of the scheduled stop date/time field matches the date and time described in the event log (change-notifying-event information) that is extracted in S201. And if such a record is not found, the CPU10, which operates according to the change management program 16, advances the process to S203.

On the other hand, if the change plan DB 13 contains a record whose value of the scheduled stop date/time field matches the date and time described in the event log concerned (change-notifying-event information), in S204, the CPU 10 operating with the change management program 16 further searches for a record whose value in the host ID field matches the device ID described in the event log concerned (change-notifying-event information) from the records extracted in S202. And if such a record is not found, the CPU10, which operates according to the change management program 16, advances the process to S203.

On the other hand, if a record whose value of the host ID field matches the device ID described in the event log concerned (change-notifying-event information) is found, in S205, the CPU 10 operating with the change management program 16 checks whether the contents of resource change described in the event log concerned (change-notifying-event information) match the values in the category field, the type field, and the item field of the record found in S204. And when they do not match to each other, the CPU 10 operating with the change management program 16 advances the process to S203.

On the other hand, when they match to each other, in S206, the CPU 10 operating with the change management program 16 sets a flag in the executed flag field of the record found in S204 (the record checked in S205).

In S207 executed after S206, the CPU 10 operating with the change management program 16 sets “0” that shows matching as a return value of a comparison result. After completion of S206, the CPU 10 operating with the change management program 16 finishes the subroutine, and returns the process to the main routine of FIG. 5.

On the other hand, in S203, the CPU 10 operating with the change management program 16 sets up “1” which shows that it is not in agreement as a return value about a comparison result. After completion of S203, the CPU10 operating with the change management program 16 finishes the subroutine, and returns the process to the main routine of FIG. 5.

In S104 executed after S103 of the main routine of FIG. 5 to which the process is returned, the CPU 10 operating with the change management program 16 checks the return value set up in S203 or S207. If the return value is “1”, the CPU 10 judges that the planned resource change is not executed. In such a case, the CPU 10 outputs the screen signal (the image signal) for displaying the contents of the event log, which is extracted in S201 and checked in S202, S204 and S205, on the display 32 of the change management terminal 3 to the change management terminal 3 in S106 (corresponding to the output process). Alternatively, the CPU 10 transmits an e-mail that describes the contents of the event log to an administrator in S107 (corresponding to the output process), or the CPU 10 stores the event log concerned into the event log DB 17 in S108 (corresponding to the storing process). After the above-mentioned notifications, the CPU 10 operating with the change management program 16 finishes the process.

On the other hand, when the CPU 10 judges that the return value set up in S203 or S207 is “0” in S104, the CPU 10 operating with the change management program 16 judges that the resource was changed as planned. Then, the CPU 10 advances the process to S105. In S105, the CPU 10 operating with the change management program 16 indicates that it is as planned on the display 32 of the change management terminal 3, and notifies an administrator of that via an e-mail. And, the CPU 10 stores the event log, which is extracted in S201 and checked in S202, S204 and S205, into the event log DB 17. After the above-mentioned notifications, the CPU 10 operating with the change management program 16 finishes the process.

### <Operation>

According to the embodiment constituted as above, when a resource of the managing target computer 2 is changed, the agent 25 immediately records the contents of the resource change into the event log, and the event log is transmitted to the manager 15 as the change-notifying-event information. The event log (change-notifying-event information) is received by the manager 15 of the operation management server 1, and is compared with the resource change plan stored in the change plane DB 13 by the change management program 16. As a result of the comparison, the CPU 10 judges whether the resource change shown in the event log (change-notifying-event information) was a resource change as planned. And then, the judgment result is notified to an administrator. Therefore, the administrator can recognize the fact of the resource changes in the respective managing target computers 2 in almost real time, and can know at a glance whether the resource changes are approved or not. Since the targets of search by the change management program 16 are limited to the event logs based on the actual resource changes, search load on the CPU 10 can be reduced.

### Second Embodiment

In the above-mentioned first embodiment, when an event log is notified from the agent 25, it serves as the impetus for searching the change plan DB 13 based on the contents of the event log. On the other hand, in the second embodiment, an event log that is notified from the agent 25 is once stored in the event log DB 17, and then, the change plan DB 13 is searched based on the event log stored in the event log DB 17 only when an administrator operates the change management terminal 3 to input a predetermined command to the operation management server 1. Further, in the second embodiment, when a completion of one resource change requires a plurality of resource change operations in order, a plan of the plurality of resource change operations are recorded as a “change plan task”. It is judged that the planned resource change is completed only when the operations defined in the change plan task are executed in the defined order.

### <System Configuration>

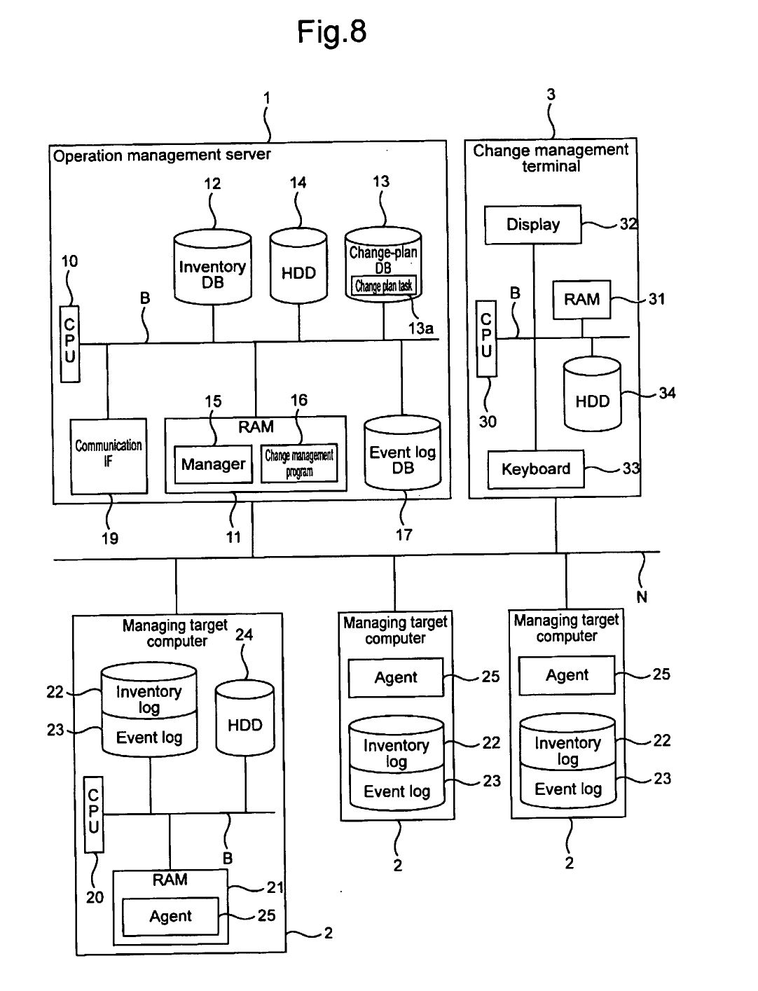

FIG. 8 is a block diagram showing an outline configuration of a network system that is managed by the change monitoring program of the second embodiment. As shown in FIGS. 1 and 8, the configuration the network system of the second embodiment is almost the same as that of the above-mentioned first embodiment. However, the above-mentioned change plan task 13a is recorded in the change plan DB 13 beforehand.

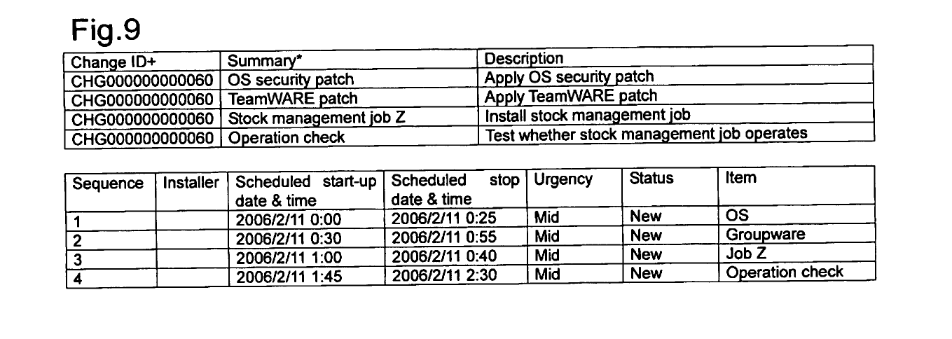

FIG. 9 is a table showing data structure of the change plan task 13a, The change plan tasks 13a consists of a plurality of records each of which is recorded in response to a resource change plan that requires a plurality of resource change operations performed in order for executing the resource change. FIG. 9 shows an example of the change plan task that consists of four resource changes recorded in connection with the resource change plan shown in FIG. 2.

As shown in FIG. 9, the change plan task 13a consists of a plurality of records each of which is created for each of the resource change operations that constitute the change plan task concerned. Each record consists of a change ID field, a summary field, a description field, a sequence field, an installer field, a scheduled start-up date/time field, a scheduled stop date/time field, an urgency field, a status field, and an item field, respectively. Among these, the identification information (changeID) that identifies resource change plan concerned uniquely is stored in the change ID field. The outline of the resource change operation concerned is stored in the summary field. The sentence to direct the contents of the resource change operation concerned is stored in the description field. The serial number that shows the execution order of the resource change operation concerned in the change plan task 13a concerned is stored in the sequence field. The identification information of an installer who performs the resource change operation concerned is stored in the installer field. The date and time when the resource change operation concerned should start is stored in the scheduled start-up date/time field. The date and time when the resource change operation concerned should stop is stored in the scheduled stop date/time field. The information about urgency (high or low) of the resource change operation concerned is stored in the urgency field. The information that shows the operation condition of the resource change operation concerned is stored in the status field. The indigenous name of the resource to be changed is stored in the item field.

### <Process>

Next, the flow of the process executed by the agent 25 of each of the managing target computer 2 and by the manager 15 of the operation management server 1 according to the second embodiment will be described. Although a flowchart is omitted, the agent 25 of each managing target computer 2 transmits a log (an inventory log, an event log) to the manager 15 by executing the process from S001 through S003 in FIG. 5 in the same manner as the first embodiment. The manager 15 classifies the received logs into the inventory logs and the event logs. And then, the manager 15 stores the inventory logs into the inventory DB 12 and stores the event logs into the event log DB 17.

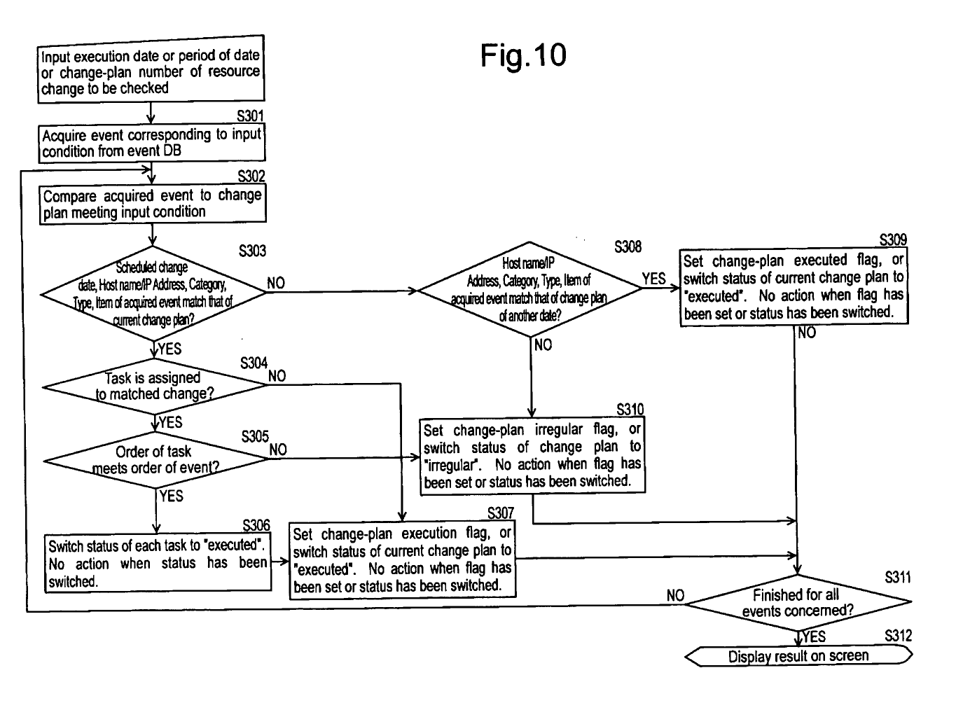

The CPU 10 that operates according to the change management program 16 of the second embodiment executes the process shown in FIG. 10. This process starts at a time when an administrator inputs an input condition, which is a specific date or period or a change ID of the resource change plan, with a predetermined command through the keyboard 33 of the change management terminal 3. The administrator inputs a specific date or period, when he or she wants to check whether the resource change planned within the specific date or period concerned is executed as planned, or when he or she wants to know what kind of resource change has been executed within the specific date or period concerned. On the other hand, the administrator inputs a change ID, when he or she wants to check whether the specific resource change has been executed as planned.

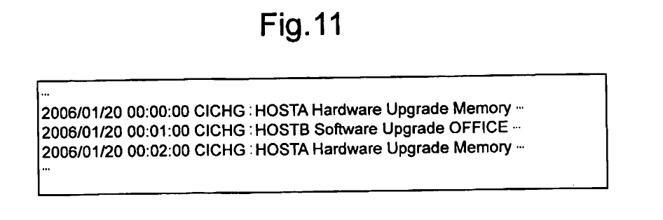

In the first step S301, the CPU 10 operating with the change management program 16 searches the event log DB for an event log matching the input condition. For example, the event logs shown in FIG. 11 are extracted when “Jan. 20, 2006” is inputted as the input condition.

Next, the CPU 10 operating with the change management program 16 executes a loop process from S302 to S311 for each of the event logs that are extracted in S301 in ascending order of the date and time.

In the first step S302 in the loop process, the CPU 10 operating with the change management program 16 retrieves all the resource change plans matching the input condition from the change plan DB 13, and compares the retrieved resource change plans with the event log concerned.

In the next step S303, the CPU 10 operating with the change management program 16 checks whether the values of the event log concerned match the values of the resource change plans retrieved in S302. That is, the CPU 10 checks whether the value of the “date and time” of the event log concerned is included in the period defined by the values stored in the scheduled start-update/time field and the scheduled stop date/time field. Further, the CPU 10 checks whether the “device ID” of the event log concerned matches the value stored in the host name field of the resource change plan. Still further, the CPU 10 checks whether the “contents” of the event log concerned match the values stored in the category field, the type field, and the item field of the resource change plan. If all the conditions are satisfied, the CPU 10 operating with the change management program 16 advances the process to S304. On the other hand, if at least one of the conditions is not satisfied, the CPU 10 advances the process to S308.

In S304, the CPU 10 operating with the change management program 16 checks whether the change plan task 13 is linked with the resource change whose check result in S303 is “YES”. That is, the CPU 10 checks whether a change planned task 13a that has the same change ID as the resource change plan concerned is recorded in the change plan DB 13. When the resource change plan concerned is linked with the change plan task 13a, the CPU 10 operating with the change management program 16 advances the process to S305. When it is not linked, the CPU 10 advances the process to S307.

In S305, the CPU 10 operating with the change management program 16 extracts event logs whose device type, device ID and owner are common to the event log concerned and having earlier date and time than the event log concerned from the event log DB 17. Then, the CPU 10 checks whether the contents and order of the series of event log including the event log concerned are different from the contents and order of the resource change operations recorded in the change plan task 13a that is linked with the resource change plan whose check result in S304 is “YES”. When the history of the resource changes until the event log concerned is not different from the change plan task 13a, the CPU 10 advances the process to S306. When it is different, the CPU 10 advances the process to S310. Namely, when the following conditions are satisfied, the CPU 10 advances the process to S306. A first condition is that the contents of the resource change described in the event log concerned match the details of the resource change operation recorded in the change plan task 13a except the date and time. Second and third conditions are required when the resource change operation concerned does not have the earliest execution order. The second condition is that the resource change described in the event log concerned matches a resource change operation having earlier order than the order of the resource change operation concerned. The third condition is that there is an event log whose date and time is earlier than the event log concerned. Otherwise, the CPU 10 advances the process to S310. The process in S303, S304, and S305 corresponds to the comparison process.

In S306, the CPU 10 operating with the change management program 16 changes the value of the status field of the resource change operation in the change plan task 13a that was checked in S305 into “executed”. There is no action when already changed. After the completion of S306, the CPU 10 operating with the change management program 16 advances the process to S307.

In S307, the CPU 10 operating with the change management program 16 sets the value “executed” in the status field of the resource change plan whose check result in S303 is “YES”, and sets a flag in the executed flag field thereof. If these fields have been changed, there is no action (corresponding to the registration process). After the completion of S307, the CPU 10 operating with the change management program 16 advances the process to S311.

On the other hand, in S308, the CPU 10 operating with the change management program 16 checks whether the “device ID” of the event log concerned matches the value in the host name field of the resource change plan and whether the “contents” of the event log concerned match the values in the category field, the value in the type field and the value in the item field (corresponding to the comparison process) for all the resource change plans retrieved in S302. The “date and time” value described in the event log to be processed is not contained within the period defined by the values stored in the scheduled start-up date/time field and the scheduled stop date/time field of the resource change plan. If there is a resource change plan that satisfies all the condition except the “date and time”, the CPU 10 operating with the change management program 16 advances the process to S309. If not, the CPU 10 advances the process to S310.

In S309, the CPU 10 operating with the change management program 16 sets the value “executed” in the status field of the resource change plan that is retrieved in S302 (the resource change plan checked in S303), and sets a flag in the executed flag field thereof (corresponding to the registration process). There is no action when these fields have been already changed. After the completion of S309, the CPU 10 operating with the change management program 16 advances the process to S311.

On the other hand, in S310, the CPU 10 operating with the change management program 16 sets the value “irregular” in the status fields of all the resource change plans that are compared in S305 or S308, and sets flags in the change-plan irregular flag fields (corresponding to the registration process). There is no action when the value of field has been already “irregular”. After the completion of S310, the CPU 10 operating with the change management program 16 advances the process to S311.

In S311, the CPU10 operating with the change management program 16 checks whether the loop process from S302 to S311 has been executed to all the event logs retrieved in S301. If the loop process has not been executed to all the event logs retrieved, the CPU 10 operating with the change management program 16 returns the process to S302 to execute the loop process to the next event log.

On the other hand, when the CPU 10 judges in S311 that the loop process has been executed to all the event logs retrieved in S301, the CPU 10 operating with the change management program 16 outputs the screen signal (the image signal) for displaying the status (executed, unexecuted, or irregular) of each of the resource change plans retrieved from the change plan DB 13 in S302 (and all the resource change operations of all the change plan tasks 13a linked to the resource change plans) on the display 32 of the change management terminal 3 to the change management terminal 3 in S312 (corresponding to the output process).

### <Operation>

According to the present invention, the comparison between an event log and a resource change plan recorded on the change plan DB 13 is not performed immediately after an actual resource change but is performed when an administrator inputs a predetermined command and an input condition after that. However, since the administrator can establish any date and time or any periods containing the same day as the input condition, he or she can check whether a resource change planned at any date and time or within any period has been executed as planned at anytime. Since other operations of the second embodiment are completely the same as that of the first embodiment mentioned above, the description thereof is omitted.

What is claimed is:

1. A change monitoring program of a computer resource on a network executed by a processor of a server computer that includes a communication device that can communicate with a managing target computer, which can voluntarily detect a resource change by executing an agent program to describe the resource change as a log and to transmit the log, through a network and a change-plan database that stores details of resource changes for said managing target computer, said program comprising:
a comparison process for comparing, when said communication device receives the log transmitted by said managing target computer, the contents of resource change described in said log to the details of each resource change stored in said change-plan database; and
a registration process to register, when the contents of said resource change described in said log matches any of the details of resource changes stored in said change-plan database, the information showing that said resource has been changed as planned to said change-plan database.

2. A change monitoring program of a computer resource on a network executed by a processor of a server computer that includes a communication device that can communicate with a managing target computer, which can voluntarily detect a resource change by executing an agent program to describe the resource change as a log and to transmit the log, through a network, a change-plan database that stores details of resource changes for said managing target computer, a log database that stores said logs, and an input device through which an administrator inputs commands, said program comprising:
a storing process for storing, when said communication device receives a log transmitted by a managing target computer, the received log into said log database;
a comparison process for comparing, when a command that designates a predetermined time period is input through said input device, the contents of resource change described in the log to the details of resource changes stored in the change-plan database for each of the logs received during said time period among the logs stored in said log database; and
a registration process to register, when the contents of said resource change described in said log matches any of the details of resource changes stored in said change-plan database, the information showing that said resource has been changed as planned to said change-plan database.

3. The change monitoring program of a computer resource on a network according to claim 1 or 2, wherein the date and time when the resource was changed are described in the contents of resource changes described in said log, a start-up date/time and a stop date/time of the period within which the resource should be changed are recorded in the details of the resource change recorded in said change plan database,
wherein said registration process makes said processor of said server computer register the information showing that said resource has been changed as planned to said change-plan database when said date and time of the contents of resource change described in said log is contained within the period defined by said start-up date/time and said stop date/time included in the contents of resource change recorded in said change plan database, and when all items except said date and time in the details of resource change described in said log match the details of the same resource change recorded in said change-plan database.

4. The change monitoring program of a computer resource on a network according to claim 3, wherein the resource changes recorded in said change plan database include a plurality of resource changes whose mutual execution orders are contained in its details, and
wherein said registration process makes said processor of said server computer register the information showing that said resource has been changed as planned to said change-plan database when the following conditions are satisfied, or register the information showing that said resource change is irregular to said change-plan database when at least one of the following conditions are not satisfied,
(i) the contents of the resource change described in said log match the details of a resource change recorded in said change plan database except the date and time,
(ii) the details of said resource change contain said execution order,
(iii) there is another log that matches a resource change having an earlier execution order than said order and that includes earlier date and time than that of said log, when said execution order is not earliest.

5. The change monitoring program of a computer resource on a network according to claim 1, wherein said registration process makes said processor of said server computer register the information showing that an unscheduled resource change has been executed together with said log into said change-plan database, when the contents of resource change described in said log do not match the details of any resource change stored in said change plan database.
